(19) United States
(12) Patent Application Publication
(10) Pub. No.: US 2013/0069520 A1
(43) Pub. Date: Mar. 21, 2013

(54) PLASMA-DISPLAY PANEL

(71) Applicants: Yoshihisa Nagasaki, Osaka (JP); Yukihiko Sugio, Osaka (JP); Masaaki Akamatsu, Osaka (JP); Kazuhiko Sugimoto, Osaka (JP)

(72) Inventors: Yoshihisa Nagasaki, Osaka (JP); Yukihiko Sugio, Osaka (JP); Masaaki Akamatsu, Osaka (JP); Kazuhiko Sugimoto, Osaka (JP)

(73) Assignee: PANASONIC CORPORATION, Osaka (JP)

(21) Appl. No.: 13/701,414

(22) PCT Filed: Feb. 17, 2012
(86) PCT No.: PCT/JP2012/001048

§ 371 Date: Nov. 30, 2012

(30) Foreign Application Priority Data
Feb. 24, 2011 (JP) 2011-038061

(51) Int. Cl. H01J 17/49; H01J 9/22

(52) U.S. Cl. CPC H01J 17/49; H01J 9/22
USPC 313/486; 445/24

(57) ABSTRACT

A phosphor layer of a plasma display panel has a green phosphor layer containing Zn₂SiO₄:Mn particles and (Y₁₋ₓ, Gdₓ)₃(Al_{1-y}, Ga_{y})₅O₁₂:Ce particles. The Zn₂SiO₄:Mn particles satisfy requirements of Zn3p/Si2p≧2.10 (1), and Zn2p/Si2p≧1.25 (2) wherein Zn3p represents an emission amount of photoelectrons emitted from a 3p orbit of a Zn element in a region up to 10 nm from surfaces of the particles, Zn2p represents an emission amount of photoelectrons emitted from a 2p orbit of the Zn element in a region up to 3 nm from the surfaces of the particles, and Si2p represents an emission amount of photoelectrons emitted from a 2p orbit of a Si element in the region up to 10 nm from the surfaces of the particles.

### TECHNICAL FIELD

The technique disclosed herein relates to a plasma display panel having a phosphor layer containing a phosphor excitable by vacuum ultraviolet rays.

### BACKGROUND ART

In a plasma display panel (hereinafter referred to as a PDP), the quality of moving-images is largely affected by the afterglow property of its phosphor in each of red, green and blue colors. When the afterglow period of the phosphor is 8 msec or longer, it is visually conceived that light emission is lasting, thus resulting in a deterioration in the display image quality. When the afterglow period is 4 msec or less, afterglow is not easily viewed with the naked eye, thus resulting in an improvement in the display image quality. The afterglow period denotes a period when the emission intensity of the phosphor turns from a peak into 1/10 thereof. Hereinafter, the same definition is used.

The afterglow period of Zn₂SiO₄:Mn or (Y, Gd)BO₃:Tb is as long as 10 msec or more for the green phosphors out of phosphors used in PDPs. Thus, Patent Literature 1 discloses a technique of mixing such a phosphor with (Y, Gd)Al₃(BO₃)₄:Tb, the afterglow period of which is short, and other techniques. However, Zn₂SiO₄:Mn is easily electrified into negative polarity. This situation is different from that of red phosphors or blue phosphors. For this reason, Zn₂SiO₄:Mn is a cause for deteriorating the discharge property of a PDP to lower the emission efficiency of the PDP. In order to make an improvement about the negative electrification, Patent Literature 2 discloses a method of coating the surface of Zn₂SiO₄:Mn, which is negatively electrified, densely with a positively electrified oxide until the polarity of the coated product turns positive.

### CITATION LIST

### Patent Literatures

PTL 1: Unexamined Japanese Patent Publication No. 10-195428
PTL 2: Unexamined Japanese Patent Publication No. H11-86735

### SUMMARY OF THE INVENTION

The PDP disclosed herein includes a front substrate, a rear substrate opposing the front substrate to form a discharge space therebetween, barrier ribs disposed on the rear substrate to partition the discharge space into a plurality of sections, and a phosphor layer disposed between the barrier ribs. The phosphor layer has a green phosphor layer containing Zn₂SiO₄:Mn particles, and (Y₁₋ₓ, Gdₓ)₃(Al_{1-y}, Ga_{y})₅O₁₂:Ce particles wherein 0≦x≦1, and 0≦y≦0.5, hereinafter the same about x and y). The Zn₂SiO₄:Mn particles satisfy the following requirements (1) and (2); requirement (1) is that Zn3p/Si2p is 2.10 or more, and requirement (2) is that Zn2p/Si2p is 1.25 or more. Herein, Zn3p represents an emission amount of photoelectrons emitted from a 3p orbit of a Zn element in a region up to 10 nm from the particle surfaces. Zn2p represents an emission amount of photoelectrons emitted from a 2p orbit of the Zn element in a region up to 3 nm from the particle surfaces. Si2p represents an emission amount of photoelectrons emitted from a 2p orbit of a Si element in the region up to 10 nm from the particle surfaces.

### BRIEF DESCRIPTION OF DRAWINGS

FIG. 1 is an exploded perspective view illustrating a main portion of a PDP in a first exemplary embodiment.

FIG. 2 is a view illustrating the arrangement of electrodes of the PDP in the first exemplary embodiment.

FIG. 3 is a view illustrating a cross section of the main portion of the PDP in the first exemplary embodiment.

FIG. 4 is a graph showing results obtained by measuring the chemical binding state of Zn in surfaces of Zn₂SiO₄:Mn particles in the first exemplary embodiment by XPS.

### DESCRIPTION OF EMBODIMENTS

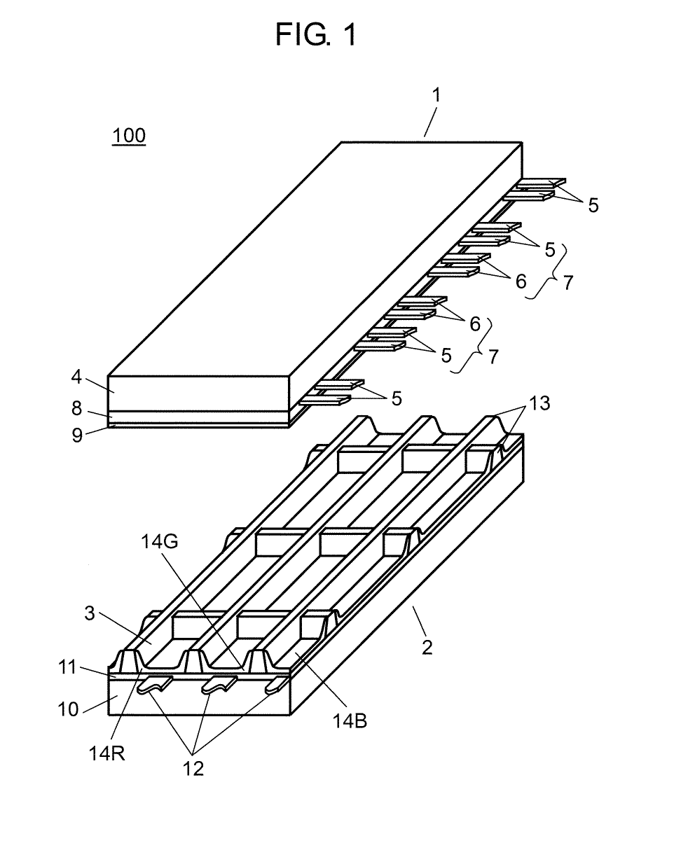

Hereinafter, a description will be made with reference to FIGS. 1 to 3 about a plasma display device having the PDP according to the technique disclosed therein. However, embodiments according to the technique disclosed herein are not limited to this embodiment.

### First Exemplary Embodiment

### 1. Structure of PDP

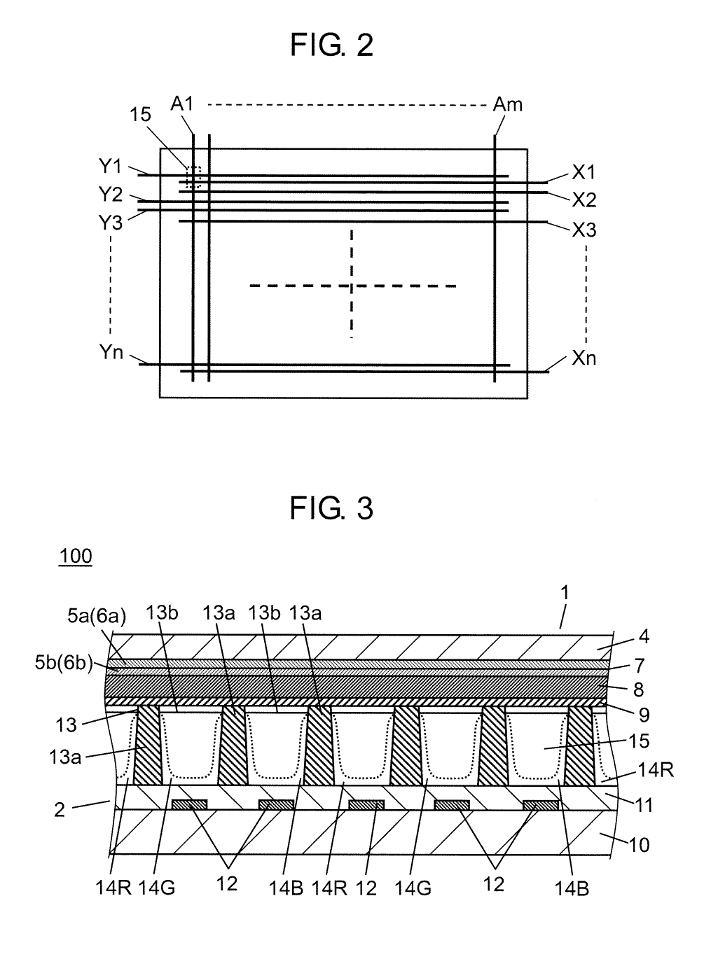

FIG. 1 is an exploded perspective view illustrating front plate 1 and rear plate 2 in PDP 100 according to the first exemplary embodiment in the state where the plates are separated from each other. FIG. 2 is a view illustrating the arrangement of electrodes of PDP 100 according to the first exemplary embodiment. FIG. 3 is a sectional view illustrating a discharge cell structure when front plate 1 and rear plate 2 are bonded to each other to form PDP 100.

As illustrated in FIGS. 1 and 3, PDP 100 has a structure formed by arranging front substrate 4 and rear substrate 10 each made of glass to oppose each other and form discharge space 3 therebetween.

Front plate 1 has, on front substrate 4 made of glass, display electrodes 7 in each of which scan electrode 5, which is an electroconductive first electrode, and sustain electrode 6, which is a second electrode, are disposed in parallel to each other in such a manner that a discharge gap MG is made therebetween. Display electrodes 7 are disposed in the direction of rows. Dielectric layer 8 made of glass material is formed to cover scan electrodes 5 and sustain electrodes 6. Protective layer 9 made of MgO is formed on dielectric layer 8. Scan electrodes 5 are each composed of transparent electrode 5a and bus electrode 5b. Sustain electrodes 6 are each composed of transparent electrode 6a and bus electrode 6b. Transparent electrodes 5a and 6a are made of ITO. Bus electrode 5b and bus electrode 6b are each made of an electroconductive metal, such as Ag, that is made into a film thickness of several micrometers, and are electrically connected to transparent electrode 5a and transparent electrode 6a, respectively.

Rear plate 2 has, on rear substrate 10 made of glass, plural data electrodes 12 covered with insulating layer 11 made of glass material, disposed in the form of stripes in the direction of columns, and made of Ag. On insulating layer 11 are located lattice-form barrier ribs 13 made of glass material in order to partition discharge space 3 between front plate 1 and rear plate 2 into individual discharge cells. Phosphor layers 14R, 14G and 14B colored in red (R), green (G) and blue (B), respectively, are disposed on the front surface of insulating layer 11 and side surfaces of barrier ribs 13. Front plate 1 and rear plate 2 are disposed oppositely to each other in such a manner that scan electrodes 5 and sustain electrodes 6 cross data electrodes 12. As illustrated in FIG. 3, discharge cell 15 is located at each of regions where scan electrodes 5 and sustain electrodes 6 cross data electrodes 12. A discharge gas such as, for example, a mixture of neon and xenon is air-tightly put into discharge space 3. The structure of PDP 100 is not limited to the above-mentioned structure. The structure may have, for example, barrier ribs in the form of stripes.

As illustrated in FIG. 3, lattice-form barrier ribs 13, which form discharge cells 15, are composed of vertical barrier ribs 13a formed in parallel to data electrodes 12, and horizontal barrier ribs 13b formed perpendicularly to vertical barrier ribs 13a. Phosphor layers 14R, 14G and 14B formed by application (or painting) into barrier ribs 13 are formed in such a manner that blue phosphor layer 14B, red phosphor layer 14R, and green phosphor layer 14G pieces are disposed, in this order, in the form of stripes along vertical barrier ribs 13a. Blue phosphor layer 14B, red phosphor layer 14R, and green phosphor layer 14G are collectively referred to as phosphor layer 14.

FIG. 2 is a view of the arrangement of the electrodes of PDP 100 illustrated in FIGS. 1 and 3. As illustrated in FIG. 2, a number n of scan electrodes Y1, Y2, Y3, . . . Yn (reference number 5 in FIG. 1), and a number n of sustain electrodes X1, X2, X3, . . . Xn (reference number 6 in FIG. 1) are disposed elongated in the row direction. Further, a number m of data electrodes A1, . . . Am (reference number 12 in FIG. 1) are disposed elongated in the column direction. Furthermore, one of discharge cells 15 is formed at a region where paired scan electrode Y1 and sustain electrode X1 cross one of data electrodes A1. As a result, a number m×n of discharge cells 15 are formed inside discharge space 3. As illustrated in FIG. 2, scan electrodes Y1 and sustain electrodes X1 are formed on front plate 1 in accordance with a recurring pattern having an arrangement of “scan electrode Y1-sustain electrode X1-sustain electrode X2-scan electrode Y2- . . . ”. These electrodes are each connected to any one of connecting terminals located at a peripheral edge region of front plate 1 and rear plate 2 outside an image display area of the plates. These electrodes are each connected to any one of connecting terminals located at a peripheral edge region of front plate 1 and rear plate 2 outside an image display area of the plates.

### 2. Method for Producing PDP

### 2-1. Method for Producing a Front Plate

Photolithography is used to form scan electrodes 5 and sustain electrodes 6 on front substrate 4. Scan electrodes 5 are each composed of transparent electrode 5a made of indium tin oxide (ITO) or some other material, and bus electrode 5b made of silver (Ag) or some other that is stacked on transparent electrode 5a. Sustain electrodes 6 are each composed of transparent electrode 6a made of indium tin oxide (ITO) or some other material, and bus electrode 6b made of silver (Ag) or some other that is stacked on transparent electrode 6a. The material of bus electrodes 5b and 6b may be an electrode paste containing a glass frit for binding particles of silver (Ag) to each other, a photosensitive resin, a solvent, and others.

First, screen printing or some other method is used to apply the electrode paste onto front substrate 4 on which transparent electrodes 5a and 6a are formed. Next, in a baking oven, the solvent in the electrode paste is removed. Next, the electrode paste is exposed to light through a photomask having a predetermined pattern. Next, the electrode paste is developed to form a bus electrode pattern. Lastly, in a baking oven, the bus electrode pattern is baked at a predetermined temperature. In other words, the photosensitive resin in the electrode pattern is removed. Moreover, the glass frit in the electrode pattern is melted. Thereafter, the workpiece is cooled to room temperature to vitrify the melted glass fit. Through the above-mentioned steps, bus electrodes 5b and 6b are formed. It is allowable to use, beside the method of screen-printing the electrode paste, sputtering, vapor deposition, or some other method.

Next, dielectric layer 8 is formed. The material of dielectric layer 8 may be a dielectric paste containing a dielectric glass frit, a resin, a solvent and others. Dielectric layer 8 is made of, for example, bismuth oxide (Bi₂O₃) based low-melting-point glass or zinc oxide (ZnO) based low-melting-point glass to have a film thickness of about 40 μm.

The dielectric paste is first applied into a predetermined thickness onto front substrate 4 to cover scan electrodes 5 and sustain electrodes 6 by die-coating or some other method. Next, in a baking oven, the solvent in the dielectric paste is removed. Lastly, in a baking oven, the dielectric paste is baked at a predetermined temperature. In other words, the resin in the dielectric paste is removed. Moreover, the dielectric glass frit is melted. Thereafter, the workpiece is cooled to room temperature to vitrify the melted dielectric glass frit. Through the above-mentioned steps, dielectric layer 8 is formed. It is allowable to use, beside the die-coating method with the dielectric paste, screen printing, spin coating, or some other method. Without using any dielectric paste, a layer that is to be dielectric layer 8 may be formed by CVD (chemical vapor deposition), or some other method.

Next, protective layer 9 is formed on dielectric layer 8. Protective layer 9 is a thin film layer having a film thickness of about 0.8 μm and made of alkaline earth metal oxides made mainly of magnesium oxide (MgO). This layer is disposed to protect dielectric layer 8 from ion-sputtering, and further stabilize the resultant in discharge start voltage or other discharge characteristics.

Through the above-mentioned process, front plate 1 is finished, which has scan electrodes 5, sustain electrodes 6, dielectric layer 8 and protective layer 9 on front substrate 4.

### 2-2. Method for Producing a Rear Plate

Photolithography is used to form data electrodes 12 on rear substrate 10. The material of data electrodes 12 may be a data electrode paste containing a glass frit for binding particles of silver (Ag) to each other to ensure conductivity, a photosensitive resin, a solvent, and others.

First, screen printing or some other method is used to apply a predetermined thickness of the data electrode paste onto rear substrate 10. Next, in a baking oven, the solvent in the data electrode paste is removed. Next, the data electrode paste is exposed to light through a photomask having a predetermined pattern. Next, the data electrode paste is developed to form a data electrode pattern. Lastly, in a baking oven, the data electrode pattern is baked at a predetermined temperature. In other words, the photosensitive resin in the data electrode pattern is removed. Moreover, the glass frit in the data electrode pattern is melted. Thereafter, the workpiece is cooled to room temperature to vitrify the melted glass frit. Through the above-mentioned steps, data electrodes 12 are formed. It is allowable to use, beside the method of screen-printing the data electrode paste, sputtering, vapor deposition, or some other method.

Next, insulating layer 11 is formed. The material of insulating layer 11 may be an insulating paste containing an insulating glass frit, a resin, a solvent and others. In the same manner as dielectric layer 8, insulating layer 11 may be made of bismuth oxide (Bi₂O₃) based low-melting-point glass or some other. Dielectric layer 11 may be made of a material into which titanium oxide (TiO₂) is incorporated in order to cause the layer to function also as a visible ray reflective layer.

First, a predetermined thickness of the insulating paste is applied by screen printing or some other method onto rear substrate 10, on which data electrodes 12 are formed, to cover data electrodes 12. Next, in a baking oven, the solvent in the insulating paste is removed. Lastly, in a baking oven, the insulating paste is baked at a predetermined temperature. In other words, the resin in the insulating paste is removed. Moreover, the insulating glass frit is melted. Thereafter, the workpiece is cooled to room temperature to vitrify the melted glass frit. Through the above-mentioned steps, insulating layer 11 is formed. It is allowable to use, beside the method of screen-printing the insulating paste, die coating, spin coating, or some other method. Without using any insulating paste, a film that is to be insulating layer 11 may be formed by CVD (chemical vapor deposition) or some other method.

Next, photolithography is used to form barrier ribs 13. The material of barrier ribs 13 may be a barrier rib paste containing a filler, a glass frit for bonding pieces of the filler to each other, a photosensitive resin, a solvent and others. First, a predetermined thickness of the barrier rib paste is applied onto insulating layer 11 by die coating or some other method. Next, in a baking oven, the solvent in the barrier rib paste is removed.

Next, the barrier rib paste is exposed to light through a photomask having a predetermined pattern. Next, the barrier rib paste is developed to form a barrier rib pattern. Lastly, in a baking oven, the barrier rib pattern is baked at a predetermined temperature. In other words, the photosensitive resin in the barrier rib pattern is removed. Moreover, the glass frit in the barrier rib pattern is melted. Thereafter, the workpiece is cooled to room temperature to vitrify the melted glass frit. Through the above-mentioned steps, barrier ribs 13 are formed. It is allowable to use, beside the photolithography, sandblasting or some other method.

Barrier ribs 13 are formed to have, for example, a height of about 0.12 mm by use of low-melting-point glass material. In the first exemplary embodiment, the height of barrier ribs 13 is set into the range of 0.1 mm to 0.15 mm; and the pitch of adjacent ones out of barrier ribs 13, to 0.15 mm in accordance with a Full Hi-Vision television having a screen size of 42 inches. The structure of PDP 100 is not limited to the above-mentioned structure. Thus, the shape of barrier ribs 13 may be in the form of stripes.

Next, phosphor layer 14 is formed. The material of phosphor layer 14 may be a phosphor paste containing phosphor particles, a binder, a solvent and others. By a dispensing method or some other, a predetermined thickness of the phosphor paste is applied onto insulating layer 11 between adjacent ones out of barrier ribs 13, and onto side surfaces of barrier ribs 13. Next, in a baking oven, the solvent in the phosphor paste is removed. Lastly, in a baking oven, the phosphor paste is baked at a predetermined temperature. In other words, the resin in the phosphor paste is removed. Through the above-mentioned steps, phosphor layer 14 is formed. It is allowable to use, besides the dispensing method, screen printing, or some other method.

Through the above-mentioned process, rear plate 2 is finished, which has data electrodes 12, insulating layer 11, barrier ribs 13 and phosphor layer 14 on rear substrate 10.

2-3. Method for Fabricating the Front Plate and the Rear Plate into One Unit

By a dispensing method or some other, a sealing/bonding paste is painted onto the periphery of rear plate 2. The painted sealing/bonding paste forms a sealing/bonding paste layer (not illustrated). Next, in a baking oven, the solvent in the sealing/bonding paste is removed. Thereafter, the sealing/bonding paste layer is pre-baked at a temperature of about 350° C. By the pre-baking, the resin component and others in the sealing/bonding paste are removed. Next, front plate 1 and rear plate 2 are disposed to oppose each other, thereby causing the display electrodes to cross data electrodes 12. Furthermore, peripheral regions of front plate 1 and rear plate 2 are held by means of a clip or some other in the state where the regions are pressed against each other. In this state, the workpiece is baked at a predetermined temperature to melt the low-melting-point glass material. Thereafter, the workpiece is cooled to room temperature to vitrify the melted low-melting-point glass material. In this way, front plate 1 and rear plate 2 are bonded to each other to seal a space air-tightly therebetween. Lastly, a discharge gas containing Ne, Xe and others is sealed into discharge space 3. The composition of the sealed discharged gas is of Ne—Xe type, which is conventionally used. The Xe content by percentage is set to 5% or more by volume, and the sealing pressure is set into the range of 55 kPa to 80 kPa. In this way, PDP 100 is finished.

### 3. Formulations of Phosphor Materials, and Producing Methods Thereof

The following describes materials of the phosphors in the individual colors, and respective methods for producing the phosphor materials. The phosphor materials used in the first exemplary embodiment are materials each produced through a solid phase reaction method.

### 3-1. Formulation of the Blue Phosphor, and Producing Method Thereof

First, a description is made of the blue phosphor material. In the first exemplary embodiment, use is made of a blue phosphor material of BaMgAl₁₀O₁₇:Eu, the afterglow period of which is short, for blue phosphor layer 14B. The blue phosphor material, BaMgAl₁₀O₁₇:Eu, is produced by the following method:

Barium carbonate (BaCO₃), magnesium carbonate (MgCO₃), aluminum oxide (Al₂O₃), and europium oxide (Eu₂O₃) are mixed with each other to set the respective amounts thereof to be matched with the composition of the phosphor. This mixture is baked in the air at 800° C. to 1,200° C., and further baked in a mixed gas atmosphere containing hydrogen and nitrogen at 1,200° C. to 1,400° C.

### 3-2. Formulation of the Red Phosphor, and Producing Method Thereof

The following describes the red phosphor material. In the first exemplary embodiment, use is made of a red phosphor material containing at least one of a (Y, Gd)(P, V)O₄:Eu phosphor or Y₂O₃:Eu phosphor, which is a red phosphor material, for red phosphor layer 14R. The red phosphor material, the (Y, Gd)(P, V)O₄:Eu phosphor or Y₂O₃:Eu phosphor, is produced by the following method: Yttrium oxide (Y₂O₃), gadolinium oxide (Gd₂O₃), vanadium oxide (V₂O₅), phosphorous pentaoxide (P₂O₅), and europium oxide (EuO₂) are mixed each other to set the respective amounts thereof to be matched with the composition of the phosphor. This mixture is baked in the air at 600° C. to 800° C., and further baked in a mixed gas atmosphere containing hydrogen and nitrogen at 1,000° C. to 1,200° C.

### 3-3. Green Phosphor, and Producing Method Thereof

### 3-3-1. Green Phosphor

First, a description is made of the green phosphor material. In the first exemplary embodiment, use is made of a green phosphor material containing Zn₂SiO₄:Mn particles, and (Y₁₋ₓ, Gdₓ)₃(Al_{1-y}, Ga_{y})₅O₁₂:Ce particles for green phosphor layer 14G. The Zn₂SiO₄:Mn particles are characterized in that Zn3p/Si2p is 2.10 or more, and Zn2p/Si2p is 1.25 or more.

Zn3p/Si2p represents the presence ratio (atomic number ratio, i.e., ratio of the number of atoms) of the Zn element in a region up to 10 nm from surfaces of the particles to the Si element in the region up to 10 nm from the surfaces of the particles. Zn2p/Si2p represents the presence ratio (atomic number ratio) of the Zn element in a region up to 3 nm from the surfaces of the particles to the Si element in the region up to 10 nm from the surfaces of the particles.

The values of Zn3p, Si2p, and Zn2p are emission amounts of photoelectrons emitted from a 3p orbit of the Zn element, from a 2p orbit of the Si element, and a 2p orbit of the Zn element, respectively. The values may be measured by an apparatus for XPS (abbreviation of X-ray photoelectron spectroscopy). XPS is called X-ray photoelectron spectroscopy, and makes it possible to analyze the chemical composition of a region within about 10 nm from a surface of a substance, and the chemical binding state therein.

The value of Zn3p is the emission amount of photoelectrons emitted from the 3p orbit of the Zn element in the region up to 10 nm from the particle surfaces of the Zn₂SiO₄:Mn particles. Herein, the photoelectron emission amount of the Zn 3p orbit is represented as the presence proportion (atomic number proportion, i.e., proportion of the number of atoms) of the Zn element to constituting elements in the region up to 10 nm from the particle surfaces.

The value of Si2p is the emission amount of photoelectrons emitted from the 2p orbit of the Si element in the region up to 10 nm from the particle surfaces of the Zn₂SiO₄:Mn particles. Herein, the photoelectron emission amount of the Si 2p orbit is represented as the presence proportion (atomic number proportion) of the Si element to the constituting elements in the region up to 10 nm from the particle surfaces.

The value of Zn2p is the emission amount of photoelectrons emitted from the 2p orbit of the Zn element in the region up to 3 nm from the particle surfaces of the Zn₂SiO₄:Mn particles. Herein, the photoelectron emission amount of the Zn 2p orbit is represented as the presence proportion (atomic number proportion) of the Zn element to constituting elements in the region up to 3 nm from the particle surfaces.

### 3-3-2. Producing Method of the Green Phosphor

The following describes, in detail, a producing method of the green phosphor in the first exemplary embodiment. Zn₂SiO₄:Mn is produced by use of a conventional solid phase reaction method, liquid phase method or liquid spraying method. The solid phase reaction method is a method of firing an oxide or carbonate material and a flux to produce the phosphor. The liquid phase method is a method of hydrolyzing an organic metal salt or a nitrate in an aqueous solution, optionally adding an alkali or some other thereto to produce a precipitation, and subjecting the produced phosphor material precursor to thermal treatment to produce the phosphor.

The liquid spraying method is a method of spraying, into a heated furnace, an aqueous solution in which raw materials of the phosphor material are incorporated to produce the phosphor. Zn₂SiO₄:Mn used in the first exemplary embodiment is not affected by the producing method. Herein, a process according to the solid phase reaction method is described as an example.

First, the mixing of the raw materials is described. As the raw materials, zinc oxide, silicon oxide and manganese carbonate (MnCO₃) are used. Similarly to the method using manganese carbonate in this way, there is known a method of using, as an initial material, manganese hydroxide, manganese nitrate, manganese halide, manganese oxalate, or some other, and causing this material to undergo a baking step, which will be detailed later, in the producing process, thereby yielding manganese oxide indirectly. Manganese oxide may be directly used.

As a material that is a zinc supplying source for Zn₂SiO₄:Mn (hereinafter, the material will be referred to as a “Zn material”), zinc oxide having a high purity (purity: 99% or more) is used. Similarly to the method using zinc oxide directly in this way, it is allowable to use as an initial material, zinc hydroxide, zinc carbonate, zinc nitrate, zinc halide, zinc oxalate or some other that has a high purity (purity: 99% or more), and causing this material to undergo the baking step, which will be detailed later, in the producing process, thereby yielding the above-mentioned zinc oxide indirectly.

As a material that is a silicon supplying source for Zn₂SiO₄:Mn (hereinafter, the material will be referred to as a “Si material”), silicon dioxide having a high purity (purity: 99% or more) may be used. A hydroxide of silicon may be used, which is yielded by hydrolyzing a silicon alkoxides compound, such as ethyl silicate.

In a specific example of the blend of the raw materials of the green phosphor, the following may be mixed: 0.16 mol of MnCO₃, 1.80 mol of ZnO, and 1.00 mol of SiO₂. For the mixing of the Mn material, the Zn material, and the Si material, use may be made of a V-shaped mixer, a blender, or some other machine that is industrially ordinarily used, or a ball mill, a vibrating mill, a jet mill, or some other machine that has a pulverizing function. In this way, mixture powder as the green phosphor material is yielded.

The following describes a baking step. In the atmospheric air, the mixture powder as the phosphor material is baked under conditions that a highest temperature of 1,200° C. is attained after about 6 hours from the start of the baking, and the firing is continued while this highest temperature is maintained over 4 hours. Thereafter, in the atmospheric air, in which temperature-lowering-operation is ordinarily made, about 12 hours are spent in lowering the temperature. The atmosphere at the baking time is not limited to the atmospheric air, and may be the atmosphere of nitrogen, or a mixed atmosphere of nitrogen and hydrogen. The highest temperature is preferably between 1,100° C. and 1,350° C. However, the highest temperature maintaining period, the temperature-raising period, the temperature-lowering period, or the like can be appropriately changed without causing any problems.

Next, (Y₁₋ₓ, Gdₓ)₃(Al_{1-y}, Ga_{y})₅O₁₂:Ce, which is another ingredient of the green phosphor material, is produced by the following method: mixed are yttrium oxide (Y₂O₃), gadolinium oxide (Gd₂O₃), aluminum oxide (Al₂O₃), gallium oxide (Ga₂O₃), and cerium oxide (CeO₂) to set the respective amounts thereof to be matched with the composition of the phosphor. This mixture is baked in the air at 1,000° C. to 1,200° C., and further baked in a mixed gas atmosphere containing oxygen and nitrogen at 1,200° C. to 1,400° C. In the present exemplary embodiment, the composition is adjusted to satisfy the following: x=0, and y=0.2. However, as long as the requirements of 0≦x≦1, and 0≦y≦0.5 are satisfied, no problem is caused even when the composition is any composition.

Zn₂SiO₄:Mn, and (Y₁₋ₓ, Gdₓ)₃(Al_{1-y}, Ga_{y})₅O₁₂:Ce prepared in this way are mixed with each other to produce a green phosphor. In the present exemplary embodiment, Zn₂SiO₄:Mn and (Y₁₋ₓ, Gdₓ)₃(Al_{1-y}, Ga_{y})₅O₁₂:Ce are mixed with each other at respective proportions of 50% by weight. However, the mixing ratio therebetween needs to be appropriately adjusted in accordance with the value of chromaticity to be designed, and the diameter of the phosphor particles. About the advantageous effect of restraining deterioration in the brightness, and that of decreasing the driving voltage, equivalent effects are obtained even when the mixing ratio is any value.

### 3-3-3. Method for Adjusting the Proportion of Zn in the Particle Surfaces of the Green Phosphor

The following describes a method for adjusting the proportion of Zn in the particle surfaces of the green phosphor. The Zn₂SiO₄:Mn powder yielded by the above-mentioned method, which has been baked, is incorporated into an aqueous solution wherein zinc nitrate is dissolved, and the solution is stirred.

At this time, it is necessary to set the weight percent concentration (wt %) of zinc nitrate in the aqueous solution relative to that of the Zn₂SiO₄:Mn powder in the aqueous solution to 300 ppm or more, the weight percent concentrations calculated in terms of the Zn element. In other words, it is necessary to set the weight of zinc ions (Zn²⁺) in the aqueous solution relative to that of the Zn₂SiO₄:Mn powder in the aqueous solution to 300 ppm or more, the weights calculated in terms of the Zn element.

Next, in the state where the baked Zn₂SiO₄:Mn powder is sufficiently dispersed in the aqueous zinc nitrate solution, ammonia water is added thereto until the pH of the aqueous solution becomes a value within the range of 8 to 11 both inclusive. This mixed liquid is filtrated and dried. Thereafter, this dried matter (filtrated matter) is baked at a temperature of 500° C. or higher. Zn₂SiO₄:Mn produced by this method is higher than Zn₂SiO₄:Mn produced by any conventional method in the presence proportion of Zn in the region up to 10 nm from the phosphor particle surfaces.

In the first exemplary embodiment, the aqueous solution wherein zinc nitrate is dissolved is used. However, the aqueous solution to be used is not limited thereto. In other words, the solution to be used may be any aqueous solution wherein a zinc salt is dissolved, that is, any aqueous solution containing zinc ions (Zn²⁺). For example, the salt may be zinc sulfate. In the first exemplary embodiment, ammonia water is used. However, the matter to be added to the Zn-salt-dissolved solution is any matter as far as the matter is an aqueous alkaline solution. The matter may be, for example, an aqueous solution of sodium hydroxide. However, it is preferred that after the firing, other metal ions (such as Na) do not remain. In the first exemplary embodiment, ammonia water is added until the pH of the aqueous solution turns into the range of 8 to 11 both inclusive. However, a desired phosphor is not obtained if the pH of the aqueous solution becomes a value less than 8, or more than 11. Since the surfaces of the Zn₂SiO₄:Mn particles can be adjusted more rapidly and more certainly, the pH of the aqueous solution is preferably in the range of 9 to 10 both inclusive. Thus, the surfaces of the Zn₂SiO₄:Mn particles can be adjusted more rapidly and more certainly.

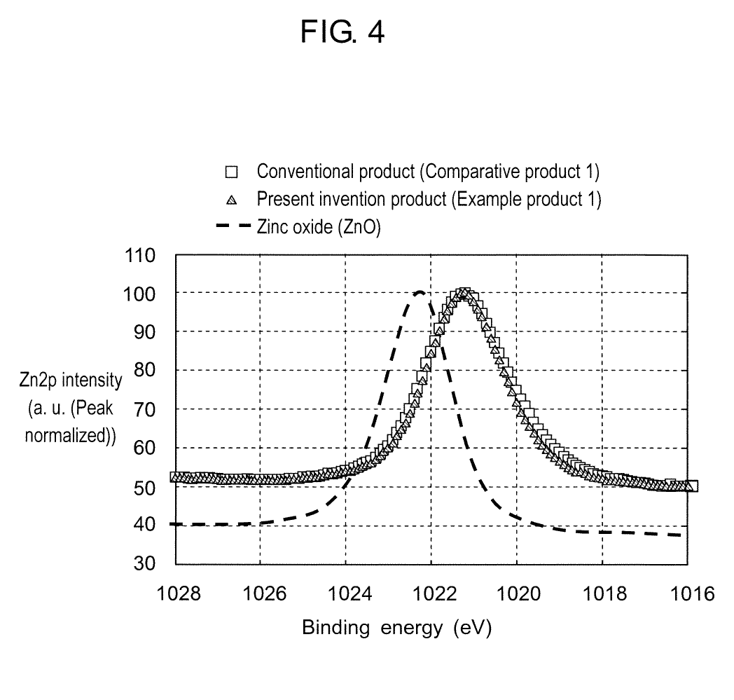

FIG. 4 is a graph for comparing Zn₂SiO₄:Mn produced by the producing method in the first exemplary embodiment and Zn₂SiO₄:Mn produced by a conventional method with regards to the chemical binding state of Zn in the region up to 10 nm from the phosphor particle surfaces. For Zn₂SiO₄:Mn produced by the producing method in the first exemplary embodiment, the Zn proportion in the particle surfaces is adjusted. On the other hand, for Zn₂SiO₄:Mn produced by the conventional method, the Zn proportion in the particle surfaces is not adjusted.

As shown in FIG. 4, the horizontal axis represents the chemical binding energy between Zn and an element adjacent thereto. The vertical axis represents the intensity (a. u.) of Zn2p that is measured by the XPS apparatus. As shown in FIG. 4, from the position of a peak of the intensity (a. u.) of Zn2p of each spectrum, the chemical binding state of Zn in the particle surfaces of the Zn₂SiO₄:Mn particles can be understood. Triangular marks show the chemical binding state of Zn in the particle surfaces of the Zn₂SiO₄:Mn particles of Example Product 1 produced by the producing method in the first exemplary embodiment. Square marks show the chemical binding state of Zn in the particle surfaces of the Zn₂SiO₄:Mn particles produced by the conventional producing method. A dot line shows the chemical binding state of Zn in the particle surfaces of zinc oxide (ZnO).

As shown in FIG. 4, the Zn₂SiO₄:Mn particles produced by the producing method in the first exemplary embodiment are consistent with the Zn₂SiO₄:Mn particles produced by the conventional producing method in the peak position of Zn2p. In other words, it can be verified that of the Zn₂SiO₄:Mn particles produced by the producing method in the first exemplary embodiment. Zn is present in the region up to 10 nm from the particle surfaces in the same chemical binding state as in the region of the Zn₂SiO₄:Mn particles produced by the conventional producing method.

Furthermore, using a green phosphor material containing Zn₂SiO₄:Mn wherein the presence proportion of Zn is adjusted, and (Y₁₋ₓ, Gdₓ)₃(Al_{1-y}, Ga_{y})₅O₁₂, the following evaluation test has been made.

### 4. Actual Device Evaluating Test Results

In Table 1 are shown actual-device-evaluated results of each PDP 100 having green phosphor layer 14G containing Zn₂SiO₄:Mn and (Y₁₋ₓ, Gdₓ)₃(Al_{1-y}, Ga_{y})₅O₁₂:Ce in the first exemplary embodiment. In the present test evaluation, Comparative Products 1 and 2, and Example Products 1 to 10 are each an example wherein Zn₂SiO₄:Mn and (Y₁₋ₓ, Gdₓ)₃(Al_{1-y}, Ga_{y})₅O₁₂:Ce are mixed with each other at respective proportions of 50% by weight.

In order to examine Comparative Example Products 1 and 2, and Example Products 1 to 10 about panel performances thereof, in Table 1 are shown results obtained by evaluating these products about relative brightness, brightness maintenance factor, and discharge start voltage. Comparative Example Product 1 is a PDP having a green phosphor layer containing Zn₂SiO₄:Mn and (Y₁₋ₓ, Gdₓ)₃(Al_{1-y}, Ga_{y})₅O₁₂:Ce produced by a conventional method. Comparative Example Product 2 is a PDP having a green phosphor layer containing Zn₂SiO₄:Mn and (Y₁₋ₓ, Gdₓ)₃(Al_{1-y}, Ga_{y})₅O₁₂:Ce, produced by a conventional method, and containing zinc nitrate in a proportion of 100 ppm relative to Zn₂SiO₄:Mn.

Example Products 1 to 10 are each PDP 100 having Zn₂SiO₄:Mn in which the presence proportion of Zn in particle surfaces of the phosphor is adjusted. In other words, about Example Products 1 to 10, Zn3p/Si2p, as well as Zn2p/Si2p, is varied in accordance with conditions for the production. Furthermore, conditions for the production of the phosphor in each of the actual devices, and the surface composition of the phosphor are also shown. The Zn post-treatment proportion (ppm) denotes the weight percent concentration (wt %) of zinc nitrate relative to that of the Zn₂SiO₄:Mn powder in the producing process, the weight percent concentrations calculated in terms of the Zn element. The thermal treatment temperature therein denotes a temperature for baking the filtrated matter in the baking step after the addition of zinc nitrate.

Zn3p/Si2p, as well as Zn2p/Si2p, denotes the presence ratio between the numerator and the denominator in each of the Zn₂SiO₄:Mn species produced under the individual production conditions.

### 4-1. Brightness Evaluation

The above-mentioned green phosphors are each used to produce PDP 100 wherein green phosphor layer 14G is formed. A drive circuit and others are connected to PDP 100 to produce a PDP device. In this PDP device, only green phosphor layer 14 G is caused to emit light, and then the initial brightness thereof is measured. The initial brightness of each of the Example Products is represented by a value relative to the initial brightness of Comparative Example Product 1 regarded as a value of 100.

### 4-2. Brightness Lifespan

In order to evaluate each of the PDP devices about brightness lifespan, the brightness maintenance factor is calculated. About the brightness maintenance factor, the PDP device is lighted to give green color continuously over 1,000 hours, and subsequently the brightness thereof is measured. The brightness maintenance factor is calculated out on the basis of the brightness of the lighting at the initial stage.

### 4-3. Driving Voltage Evaluation

In order to evaluate each of the PDP devices about driving voltage, the discharge start voltage characteristic is evaluated. About the discharge start voltage characteristic, the following is measured as the discharge start voltage: a voltage difference between the sustain electrodes necessary for generating sustain discharge in discharge cells 15 in the PDP device after address discharge is caused. In Table 1 are shown the difference of the discharge start voltage of Comparative Example Product 1 and those of Example Products.

### 4-4. Specifications and Performance Evaluation Results of Individual Tested Products

TABLE 1

| | | | | | Panel performances | | |
|---|---|---|---|---|---|---|---|
| | | | | | | | Discharge |
| | | | | | | | start |
| | Zn₂SiO₄:Mn producing | | | | Relative | Brightness | voltage |
| | conditions | | | | brightness | maintenance | (ΔV: |
| | Zn | | Zn₂SiO₄:Mn | | (value | factor (%) | difference |
| | post- | Thermal | surface | | relative to | after lighting | from that |
| | treatment | treatment | composition | | that of | over 1,000 | of |
| | proportion | temperature | Zn3p/ | Zn2p/ | Comparative | hours | Comparative |
| | (ppm) | (° C.) | Si2p | Si2p | Product 1) | (%) | Product 1) |
| Comparative | 0 | — | 2.03 | 1.21 | 100 | 91.9 | ±0 |
| Product 1 | | | | | | | |
| Comparative | 100 | 500 | 2.06 | 1.23 | 100 | 92.2 | ±0 |
| Product 2 | | | | | | | |
| Example | 300 | 500 | 2.10 | 1.25 | 100 | 92.5 | −1 |
| Product 1 | | | | | | | |
| Example | 500 | 550 | 2.13 | 1.27 | 101 | 92.5 | −2 |
| Product 2 | | | | | | | |
| Example | 1000 | 550 | 2.18 | 1.31 | 102 | 92.9 | −2 |
| Product 3 | | | | | | | |
| Example | 3000 | 550 | 2.61 | 1.69 | 102 | 93.3 | −3 |
| Product 4 | | | | | | | |
| Example | 5000 | 550 | 2.77 | 1.80 | 104 | 93.7 | −4 |
| Product 5 | | | | | | | |
| Example | 7000 | 600 | 2.83 | 1.84 | 103 | 93.8 | −3 |
| Product 6 | | | | | | | |
| Example | 10000 | 600 | 2.96 | 1.90 | 101 | 94.1 | −4 |
| Product 7 | | | | | | | |
| Example | 20000 | 600 | 3.12 | 2.00 | 100 | 94.2 | −4 |
| Product 8 | | | | | | | |
| Example | 20000 | 500 | 3.11 | 2.12 | 99 | 94.3 | −3 |
| Product 9 | | | | | | | |
| Example | 30000 | 600 | 3.14 | 2.11 | 98 | 94.5 | −4 |
| Product 10 | | | | | | | |

As shown in Table 1, for each of Example Products 1 to 10, Zn3p/Si2p is 2.10 or more, and further Zn2p/Si2p is 1.25 or more. The relative brightness of example Products 1 to 10 is substantially equal to or more than Comparative Example Products 1 and 2. Further, each of example Products 1 to 10 has higher brightness maintenance factors than Comparative Example Products 1 and 2 after the products are lighted over 1,000 hours. Furthermore, Example Products 1 to 10 have lower discharge start voltages than Comparative Example Products 1 and 2. Thus, PDP devices long in lifespan and low in consumption power can be realized.

At this time, the Zn post-treatment proportion needs to be set to 300 ppm or more. When the Zn post-treatment proportion is set to 300 ppm or more, panel performances (of the PDPs) can be improved.

Out of Example Products 1 to 10, Example Products 1 to 8, wherein Zn2p/Si2p is from 1.25 to 2.00 both inclusive, the relative brightness to that of Comparative Example Product 1 is 100% or more. Thus, PDP devices higher in brightness can be realized.

Accordingly, when Zn3p/Si2p of Zn₂SiO₄:Mn is 2.10 or more and Zn2p/Si2p thereof is from 1.25 to 2.00 both inclusive, PDP 100 long in lifespan, low in consumption power, and high in brightness can be realized.

For panel performances of PDP 100, the Zn post-treatment proportion is preferably 3,000 ppm or more. Particularly with respect to the discharge start voltage, PDP 100 is better than Comparative Example Products 1 and 2. The Zn post-treatment proportion is preferably 50,000 ppm or less in consideration against a fall in the relative brightness. For the panel performances of PDP 100, the Zn post-treatment proportion and the thermal treatment temperature are more preferably 20,000 ppm or less, and 550° C. or higher, respectively so that the brightness maintenance factor can be made higher and the discharge start voltage can be made lower than that of Comparative Example Products 1 and 2 without lowering the relative brightness. The thermal treatment temperature is preferably from 400° C. to 700° C. both inclusive, more preferably from 500° C. to 600° C. both inclusive, even more preferably from 550° C. to 600° C. both inclusive.

For panel performances of PDP 100, Zn3p/Si2p would preferably be 3.30 or smaller in consideration against a fall in the relative brightness. Zn2p/Si2p is also preferably 2.00 or less so that the brightness maintenance factor can be made higher and the discharge start voltage can be made lower than that of Comparative Example Products 1 and 2 without lowering the relative brightness. For the panel performances of PDP 100, Zn3p/Si2p and Zn2p/Si2p are more preferably 2.50 or more, and 1.50 or more, respectively; the PDP in this case is better in Comparative Example Products 1 and 2, in particular, in discharge start voltage.

### 5. Summary of First Exemplary Embodiment

Conventionally, even when (Y, Gd)Al₃(BO₃)₄:Tb is mixed with Zn₂SiO₄:Mn (afterglow period: usually 8 msec to 14 msec), there are caused problems that the phosphor becomes narrow in color range and further the afterglow period cannot be made shorter than 4 msec. Moreover, even when the surface of Zn₂SiO₄:Mn is coated with a positively-electrified oxide, impure gases originating from the coating are incorporated into PDP 100 to cause a problem that a sufficiently advantageous effect is not given against the restraint of a fall in the initial brightness of the panel.

Thus, an object of the technique disclosed herein is to solve the problems and provide a PDP giving green light emission high in brightness, and attaining an extension of the lifespan thereof, and a decrease in the driving voltage thereof.

The first exemplary embodiment has been described as an exemplary embodiment of the technique for solving the problems. Hereinafter, characteristics of the first exemplary embodiment are recited. The technique disclosed herein is not limited to the recitation. A matter described with parentheses following each structural element is a specific example of the structural element. The structural element is not limited to the specific example.

### (A)

PDP (100) as disclosed as the first exemplary embodiment includes front substrate (4), rear substrate (10) disposed confronting the front substrate (4) to form discharge space (3) therebetween, barrier ribs (13) disposed on rear substrate (10) to partition discharge space (3) into a plurality of sections, and phosphor layer (14) disposed between barrier ribs (13). Phosphor layer (14) has a green phosphor layer (14G) containing Zn₂SiO₄:Mn particles, and (Y₁₋ₓ, Gdₓ)₃(Al_{1-y}, Ga_{y})₅O₁₂:Ce particles The Zn₂SiO₄:Mn particles satisfy requirements (1) and (2). Requirement (1) is that Zn3p/Si2p is 2.10 or more, and requirement (2) is that Zn2p/Si2p is 1.25 or more. Herein, Zn3p represents the emission amount of photoelectrons emitted from the 3p orbit of the Zn element in a region up to 10 nm from particle surfaces of the Zn₂SiO₄:Mn particles. Zn2p represents the emission amount of photoelectrons emitted from the 2p orbit of the Zn element in a region up to 3 nm from the particle surfaces of the Zn₂SiO₄:Mn particles. Si2p represents the emission amount of photoelectrons emitted from the 2p orbit of the Si element in the region up to 10 nm from the particle surfaces of the Zn₂SiO₄:Mn particles.

This structure makes it possible to lower the driving voltage of PDP (100) and further realize a low consumption power and a long lifespan for PDP (100) while a fall in the light emission efficiency is restrained when PDP (100) is continuously lighted.

### (B)

In plasma display panel (100) according to item (A), the Zn₂SiO₄:Mn particles further satisfy requirement (3). Requirement (3) is that Zn3p/Si2p is 3.30 or less.

This structure makes it possible to realize a high brightness and a high light emission efficiency about PDP (100).

### (C)

In the plasma display panel according to item (A) or (B), the Zn₂SiO₄:Mn particles further satisfy requirement (4). Requirement (4) is that Zn2p/Si2p is 2.00 or less.

This structure makes it possible to realize a higher brightness, a higher light emission efficiency and a longer lifespan about PDP (100).

### (D)

In plasma display panel (100) according to item (C), the Zn₂SiO₄:Mn particles further satisfy requirements (5) and (6). Requirement (5) is that Zn3p/Si2p is 2.50 or more; and requirement (6) is that Zn2p/Si2p is 1.50 or more.

This structure makes it possible to realize PDP (100) having an even higher brightness and light emission efficiency, and an even longer lifespan.

### (E)

A plasma display device disclosed in this item has PDP (100) according to item (A) or (B).

This structure makes it possible to lower the driving voltage of the plasma display device, and further realize a low consumption power and a long lifespan about the plasma display device while a fall in the light emission efficiency is restrained when the PDP is continuously lighted.

### (F)

A plasma display device disclosed in this item has PDP (100) according to item (C).

This structure makes it possible to realize a higher brightness, a higher light emission efficiency and a longer lifespan about PDP.

### (G)

A method disclosed in this item for producing plasma display panel (100) is a method for producing PDP (100) which is a PDP including green phosphor layer (14G) containing Zn₂SiO₄:Mn particles, and (Y₁₋ₓ, Gdₓ)₃(Al_{1-y}, Ga_{y})₅O₁₂:Ce particles, wherein an aqueous solution containing a Zn₂SiO₄:Mn powder and a zinc salt has a pH in a range from 8 to 11 both inclusive. In this aqueous solution, the weight percent concentration of the zinc salt relative to that of the Zn₂SiO₄:Mn powder is set to 300 ppm or more, the weight percent concentrations calculated in terms of the Zn element.

This method makes it possible to lower the driving voltage of plasma display device (100), and further realize a low consumption power and a long lifespan about plasma display device (100) while a fall in the light emission efficiency is restrained when PDP (100) is continuously lighted.

### (H)

The method for producing plasma display panel (100) according to item (G) is a method wherein in the aqueous solution, the weight percent concentration of the zinc salt relative to that of the Zn₂SiO₄:Mn powder is set to 3,000 ppm or more, the weight percent concentrations calculated in terms of the Zn element.

This method makes it possible to realize a higher brightness, a higher light emission efficiency and a longer lifespan about PDP (100).

### (I)

The method for producing plasma display panel (100) according to item (G) or (H) is a method wherein the aqueous solution further contains an alkaline solution.

This method makes it possible to realize an even higher brightness, an even higher light emission efficiency and an even longer lifespan about PDP (100).

### (J)

The method for producing plasma display panel (100) according to item (I) is a method wherein a matter filtrated from the aqueous solution is baked at a temperature of 400° C. or higher.

This method makes it possible to realize an even higher brightness, and light emission efficiency, and an even longer lifespan about PDP (100).

### (K)

The method for producing plasma display panel (100) according to item (G) or (H) is a method wherein the zinc slat is zinc nitrate.

### (L)

The method for producing plasma display panel (100) according to item (I) is a method wherein the alkaline solution is ammonia water.

### (M)

A method disclosed in this item for producing plasma display panel (100) is a method for producing PDP (100) which is a PDP including green phosphor layer (14G) containing Zn₂SiO₄:Mn particles, and (Y₁₋ₓ, Gdₓ)₃(Al_{1-y}, Ga_{y})₅O₁₂:Ce particles, the method including: mixing a Zn₂SiO₄:Mn powder with an aqueous solution wherein the weight percent concentration of zinc nitrate relative to that of the Zn₂SiO₄:Mn powder is 300 ppm or more, the weight percent concentrations calculated in terms of the Zn element; and mixing the mixed aqueous solution with ammonia water to give a pH in a range from 8 to 11 both inclusive.

This method makes it possible to realize a higher brightness, light emission efficiency and a longer lifespan about PDP (100).

### (N)

The method for producing plasma display panel (100) according to item (M) is a method wherein a matter filtrated from the mixed aqueous solution is baked at a temperature of 400° C. or higher.

This method makes it possible to realize an even higher brightness and light emission efficiency and an even longer lifespan about PDP (100).

### INDUSTRIAL APPLICABILITY

The present invention, or the technique disclosed herein can realize a PDP device long in lifespan, low in consumption power, and high in brightness, and is useful for a large-screen display device and others.

### REFERENCE MARKS IN THE DRAWINGS

1 Front plate
2 Rear plate
3 Discharge space
4 Front substrate
5 Scan electrodes
6 Sustain electrodes
8 Dielectric layer
9 Protective layer
10 Rear substrate
11 Insulating layer
12 Data electrodes
13 Barrier ribs
13a Vertical barrier ribs
13b Horizontal barrier ribs
14 Phosphor layer
14R Red phosphor layer
14G Green phosphor layer
14B Blue phosphor layer
15 Discharge cell

1. A plasma display panel comprising:
a front substrate;
a rear substrate opposing the front substrate to form a discharge space therebetween;
barrier ribs disposed on the rear substrate to partition the discharge space into a plurality of sections; and
a phosphor layer disposed between the barrier ribs,
wherein the phosphor layer comprises a green phosphor layer containing Zn₂SiO₄:Mn particles, and (Y₁₋ₓ, Gdₓ)₃(Al_{1-y}, Ga_{y})₅O₁₂:Ce particles wherein 0≦x≦1, and 0≦y≦0.5, and
the Zn₂SiO₄:Mn particles satisfy the following requirements (1) and (2):
Zn3p/Si2p≧2.10 (1)
Zn2p/Si2p≧1.25 (2)
where Zn3p is an emission amount of photoelectrons emitted from a 3p orbit of a Zn element in a region up to 10 nm from surfaces of the particles,
Zn2p is an emission amount of photoelectrons emitted from a 2p orbit of the Zn element in a region up to 3 nm from the surfaces of the particles, and
Si2p is an emission amount of photoelectrons emitted from a 2p orbit of a Si element in the region up to 10 nm from the surfaces of the particles.

2. The plasma display panel according to claim 1, wherein the Zn₂SiO₄:Mn particles further satisfy the following requirement (3):
3.30≧Zn3p/Si2p (3)

3. The plasma display panel according to claim 1, wherein the Zn₂SiO₄:Mn particles further satisfy the following requirement (4):
2.00≧Zn2p/Si2p (4)

4. The plasma display panel according to claim 3, wherein the Zn₂SiO₄:Mn particles further satisfy the following requirements (5) and (6):
Zn3p/Si2p≧2.50 (5)
Zn2p/Si2p≧1.50 (6)

5. A method for producing a plasma display panel comprising a green phosphor layer containing Zn₂SiO₄:Mn particles, and (Y_{1-X}, Gdₓ)₃(Al_{1-y}, Ga_{y})₅O₁₂:Ce particles wherein 0≦x≦1, and 0≦y≦0.5,
wherein an aqueous solution containing a Zn₂SiO₄:Mn powder and a zinc salt has a pH in a range from 8 to 11 both inclusive, and
a weight percent concentration of the zinc salt in the aqueous solution relative to that of the Zn₂SiO₄:Mn powder is set to 300 ppm or more, the weight percent concentrations calculated in terms of the Zn element.

6. The method for producing a plasma display panel according to claim 5, wherein the weight percent concentration of the zinc salt in the aqueous solution relative to that of the Zn₂SiO₄:Mn powder is set to 3,000 ppm or more, the weight percent concentrations calculated in terms of the Zn element.

7. The method for producing a plasma display panel according to claim 5, wherein the aqueous solution further contains an alkaline solution.

8. The method for producing a plasma display panel according to claim 7, wherein a matter filtrated from the aqueous solution is baked at a temperature of 400° C. or higher.

9. The method for producing a plasma display panel according to claim 5, wherein the zinc slat is zinc nitrate.

10. The method for producing a plasma display panel according to claim 7, wherein the alkaline solution is ammonia water.

11. A method for producing a plasma display panel comprising a green phosphor layer containing Zn₂SiO₄:Mn particles, and (Y₁₋ₓ, Gdₓ)₃(Al_{1-y}, Ga_{y})₅O₁₂:Ce particles, where 0≦x≦1, and 0≦y≦0.5,
the method comprising:
mixing a Zn₂SiO₄:Mn powder with an aqueous solution wherein the weight percent concentration of zinc nitrate relative to that of the Zn₂SiO₄:Mn powder is set to 300 ppm or more, and the weight percent concentrations are calculated in terms of the Zn element; and
mixing the mixed aqueous solution with ammonia water to give a pH in a range from 8 to 11 inclusive.

12. The method for producing a plasma display panel according to claim 11, wherein a matter filtrated from the aqueous solution is baked at a temperature of 400° C. or higher.
